(19) United States
(12) Patent Application Publication
(10) Pub. No.: US 2005/0021645 A1
(43) Pub. Date: Jan. 27, 2005

(54) Universal presence indicator and instant messaging system

(76) Inventors: Kiran Kulkarni, Mumbai (IN); Mahesh Murthy, Mumbai (IN); Vinod Panicker, Mumbai (IN)

Correspondence Address: JONES DAY, 222 EAST 41ST ST, NEW YORK, NY, 10017, US

(21) Appl. No.: 10/857,708

(22) Filed: May 27, 2004

Related U.S. Application Data
(60) Provisional application No. 60/473,501, filed on May 27, 2003.

(51) Int. Cl. G06F 15/16

(52) U.S. Cl. 709/206

(57) ABSTRACT

A universal presence indication and messaging system enables integrating the presence of a user into all platforms enables the user of this technology on a wired or wireless network to configure, manage and broadcast his presence to a defined or undefined set of other users on a wired or wireless network. The recipients of a presence file or image can then interact with the user through text, voice or other medium without the need for any additional software aside from standard web browser or e-mail software. The system is also independent of the operating environment of the user and the receiver of the presence indication, and independent of the need for any proprietary messaging system. This Universal Presence Indication is also fully manageable by the user.

### REFERENCE TO RELATED APPLICATIONS

This application claims priority to U.S. provisional patent application Ser. No. 60/473,501, filed on May 27, 2003, entitled “Universal Presence Indication and Instant Messaging System”, which is herein incorporated by reference in its entirety.

### FIELD OF THE INVENTION

The present invention relates to improved systems and methods for providing communication, and more particularly to a system and method for improved presence indication and instant messaging.

### BACKGROUND OF THE INVENTION

Advances in communication technology have been directed at streamlining a method of personal communication without the requirement for face to face contact. Communication technology has extensively relied on computer networks, such as the internet, for storage and retrieval of a vast reservoir of information, as well as providing the communications media.

It is known that any individual with access to the internet can establish an electronic mail (email) account from any number of email service providers to communicate a message to an intended email recipient. This is true even if the recipient has a different service provider than the sender. As with the telephone, email is based on a standard communication protocol that allows the communication of messages between individuals that may have different service providers. To correspond across the standard communications protocols on which the telephone or email are based, the user need not be aware of the media services provider of the recipient; all that is required to complete a transmission is the recipient's telephone number or email address.

A more recent iteration of electronic communication, known as instant messaging (IM) combines attributes of both telephonic conversation and email correspondence. A typical IM exchange involves two or more users engaging in an online conversation, or chat, without the requirement of entering a message recipient's email address prior to each transmission. With IM, a user sends an instant message to a recipient by typing a message on a keyboard and pressing a transmit or “send” button, or by simply hitting the “enter” key. In this streamlined manner, IM users can “chat” by corresponding textually at a tempo approaching a conversational pace. Because IM enables a contemporaneous textual exchange, it is now a preferred method of distance communication with myriad uses.

Another development related to IM is an ability by a user to broadcast “presence,” or log-on status, through a particular service provider across a network. Presence data allows users to monitor other subscribers' network activity to determine the other subscribers availability to communicate across the network, for example, through an IM session.

Currently, a user is only capable of viewing presence data for, or engaging in IM with, other subscribers who are currently logged on to the same service provider as the user. Unlike telephone and email, no standard communication protocol is utilized with IM. Consequently, any person wishing to communicate with each other through IM must download the same client from the same IM service provider and chat across this same IM service. Thus, proprietary IM architecture creates incompatible, or closed, user groups within each of the IM service providers. Even a user who both service provider 1 and service provider 2 will not be able to communicate to users of service provider 2 through service provider 1. Proprietary system architecture precludes communication across the several closed user groups. A method that enables contemporaneous exchange and instant communication among computer users that does not rely on closed-group communication platforms would be highly advantageous.

Another shortcoming of prior approaches is that presence data, e.g., information regarding a user's network activity and status, is broadcast only through the user interface provided by the system. Such systems do not allow for communication between registered users and non-registered users. There remains a need for a platform-agnostic communication system that allows a user to convey presence data to and communicate with individuals over a network without requiring cumbersome registration by recipients of the presence data to any particular messaging service provider.

Currently, presence data and instant messaging occurs only through the proprietary IM platforms, necessitating log-on procedures for each closed user group within which collaboration is desired. Collaboration that requires the collaborators to separately log-on to the same proprietary IM service providers to enable, first, presence detection, and second, IM exchange is cumbersome.

### SUMMARY OF THE INVENTION

The present invention pertains to a universal presence indication and instant messaging system which permits presence indication and instant messaging between a defined or undefined set of users and subscribers that are associated with computing systems that are interconnected by a computer network.

Universal Presence Indication and Instant Messaging System is a technology that enables the user of this technology on a wired or wireless network to configure, manage and broadcast his/her presence to a defined or undefined set of other users on a wired or wireless network where the receivers of this Universal Presence Indication can then interact with the user through text, voice or other medium without the need for any additional software over and above a web browser, e-mail client or other general communication software that is commonly found on systems today. Universal Presence Indication and Instant Messaging technology is also independent of the operating environment of the user and the receiver of the Presence Indication, and independent of the need for any proprietary messaging system. This Universal Presence Indication is also fully manageable by the user.

In effect, the system allows the user to embed his presence through a text, graphic or other tag on his email, web page, mobile, internet-based, wired, wireless or other networked system, and make it available to any other user of any email, web page, mobile, internet-based, wired, wireless or other networked system, and then facilitating the immediate communication of two or more users if so desired by them.

In one embodiment, a user is provided a user interface to log on to a program module that provides a set of instructions and functions to support commands that are recognized by any environment that supports an HTTP call including, but not limited to email, bulletin boards, online auction sites, web pages, wireless communication devices and weblogs.

The program module further facilitates broadcasting a user's presence in any environment that supports an HTTP call, including the aforementioned environments, with a presence indicator. The presence indicator may be an icon embedded in a conspicuous location in the environment, such as a signature file, and is viewable by any subscriber of the environment without regard to the subscriber's service provider. The program module further supports a request function permitting a subscriber to request an instant message session with the user. Instant messaging and presence indication between the user and subscriber are enabled without the need for the user and subscriber to be logged on to a common service provider.

### BRIEF DESCRIPTION OF THE DRAWINGS

Additional objects and features of the invention will be more readily apparent from the following detailed description and appended claims when taken in conjunction with the drawings, in which:

FIG. 1 is a schematic illustration of a computer network system for providing instant messaging communication;

FIG. 2 is a more detailed schematic illustration of the system of FIG. 1;

FIG. 3 is a flow diagram of a general process for initiating instant message communication using an embedded presence signature;

FIG. 4 is a flow diagram of a process for logging on to the UPIIM system through an application program;

FIGS. 5A-5C are screenshots of user windows during the login process of FIG. 4;

FIG. 6 is a flow diagram of a process for logging on to the UPIIM system through a web browser;

FIG. 7 is a screenshot of a User window displayed during the login process of FIG. 6;

FIGS. 8A-8B are screenshots of additional User windows displayed during the login process of FIG. 6;

FIG. 9 is a flow diagram of a process for rendering a User's presence signature by a Subscriber;

FIG. 10 is a flow diagram of a process for initiating a chat session using the UPIIM system;

FIG. 11A-11C are screenshots of chat session request pages showing different User presence statuses;

FIG. 12 is a flow diagram of a process for continuing the chat session initiated in FIG. 10;

FIG. 13A is a screenshot showing User and Subscriber instant messaging windows during the process of FIG. 12;

FIG. 13B is a screenshot showing text formatting options in the instant messaging windows of FIG. 13A;

FIG. 13C is a screenshot showing emoticon options in the instant messaging windows of FIG. 13A;

FIG. 14 is a screenshot of a log-off notification window;

FIG. 15 is a screenshot of a window notifying a Subscriber that the User is unable to chat;

FIG. 16A-16B are screenshots of a User registration form;

FIG. 17 is a screenshot of a window used for creating a presence signature; and

FIG. 18A-18C are screenshots of windows displayed to a Subscriber during the process of sending an SMS to a User.

Like reference numerals refer to corresponding parts throughout the several views of the drawings.

### DETAILED DESCRIPTION OF THE PREFERRED EMBODIMENTS

### Network Environment of the UPIIM System

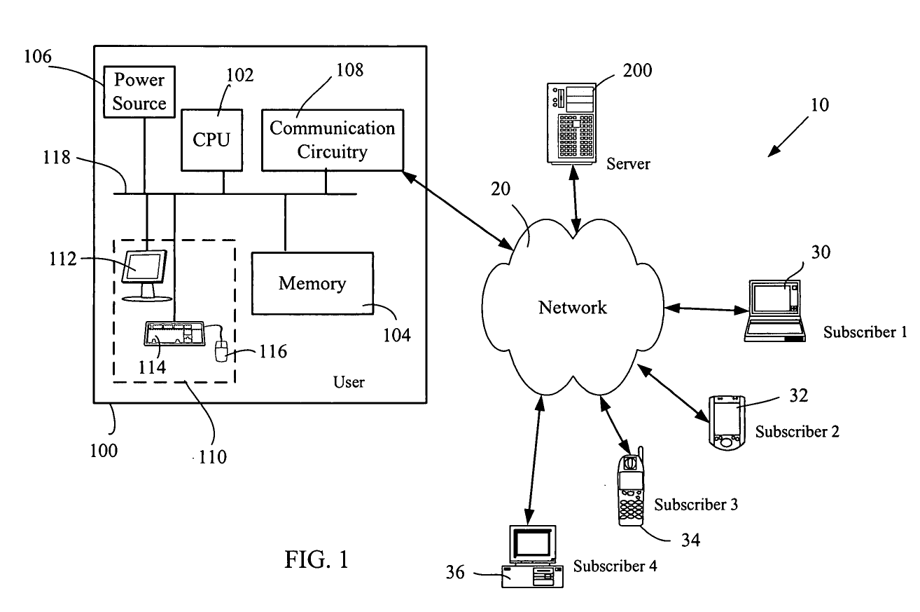

FIG. 1 and the following discussion are intended to provide a brief, general description of a suitable computing environment in which the systems and methods of the present invention my be implemented. Although it is not required, the present invention will be described in the general context of a client-server network 10 where computer-executable instructions, such as program modules, are executed by a personal computer 100 and a server 200 communicating over network 20. Generally, program modules include routines, objects, components, data structures and the like that perform particular tasks or implement particular abstract data types. The term “program” as used herein may connote a single program module or multiple program modules acting in concert. The invention may be implemented on a variety of types of computers, including personal computers (PCs), hand-held devices, multi-processor systems, microprocessor-based programmable consumer electronics, smart mobile telephones, network PCs, minicomputers, mainframe computers and the like. The invention may also be employed in distributed computing environments, where tasks are performed by remote processing devices that are linked through a communications network 20. In a distributed computing environment, modules may be located in both local and remote memory storage devices.

Referring to FIG. 1, a Universal Presence Indication and Instant Messaging System (UPIIMS or UPIIM System) includes a number of computers or other devices communicating over a network 20. The UPIIM System may also be referred to herein as UPIIMS, “LivePresence” or “IMaround”. In particular, system 10 includes a client, or User, computer 100, a server 200, and one or more Subscriber devices such as portable computer 30, a hand-held device 32, a mobile telephone 34, and a desktop computer 36. Computer 100 is capable of performing communication functions such as e-mail and web browsing, and also real-time instant messaging as described herein. The server computer 200 is capable of providing near real-time presence and instant messaging services to the User computer 100 and Subscriber devices 30, 32, 34, 36.

Network 102 may include local area network (LAN) connections, wide-area network (WAN) connections, mobile telephone networks, and the like. In one embodiment, network 102 is an internet including many well-known components, such as routers, gateways, hubs, etc., and may allow computers 100, 200, 30, 322, 34 and 36 to communicate via wired and/or wireless media.

In one embodiment, User computer 100 is a general purpose computing device in the form of a conventional personal computer, including a central processing unit (CPU) 102, a system memory 104, and a system bus 118 that couples various system components including system memory 104 to CPU 102. System bus 118 may be any of several types of bus structures including a memory bus or memory controller, a peripheral bus, and a local bus using any of a variety of bus architectures. The system memory 104 preferably includes non-volatile and volatile memory, such as read only memory (ROM) and random access memory (RAM). For example, a basic input/output system (BIOS) in memory 104, includes the basic routines that helps to transfer information between elements within computer 100, such as during start-up.

Memory 104 may also include additional storage (removable and/or non-removable) including, but not limited to, magnetic or optical disks or tape. Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disk (DVD) or other optical storage, magnetic cassettes, magnetic tape, magnetic disk storage or other magnetic storage devices, or any other medium which can be used to stored the desired information and which can be accessed by the computer 100. Any such computer storage media may be part of computer 100.

Computer 100 preferably includes communications circuitry 108 that allows computer 100 to communicate with other devices. Communications circuitry 108 includes a network interface card, modem, router, gateway or other suitable device for providing a communication connection with networks 20. A communication connection is an example of a communication medium. Communication media typically embodies computer readable instructions, data structures, program modules or other data in a modulated data signal such as a carrier wave or other transport mechanism and includes any information delivery media. By way of example, and not limitation, communication media includes wired media such as a wired network or direct-wired connection, and wireless media such as acoustic, RF, infrared and other wireless media. The term computer readable media as used herein includes both storage media and communication media.

Computer 100 may also have input devices 110 such as a keyboard 114, mouse 116, pen, voice input device, touch input device, etc. Output devices such as a display 112, speakers, a printer, etc. may also be included. All these devices are well known in the art and need not be discussed at length here.

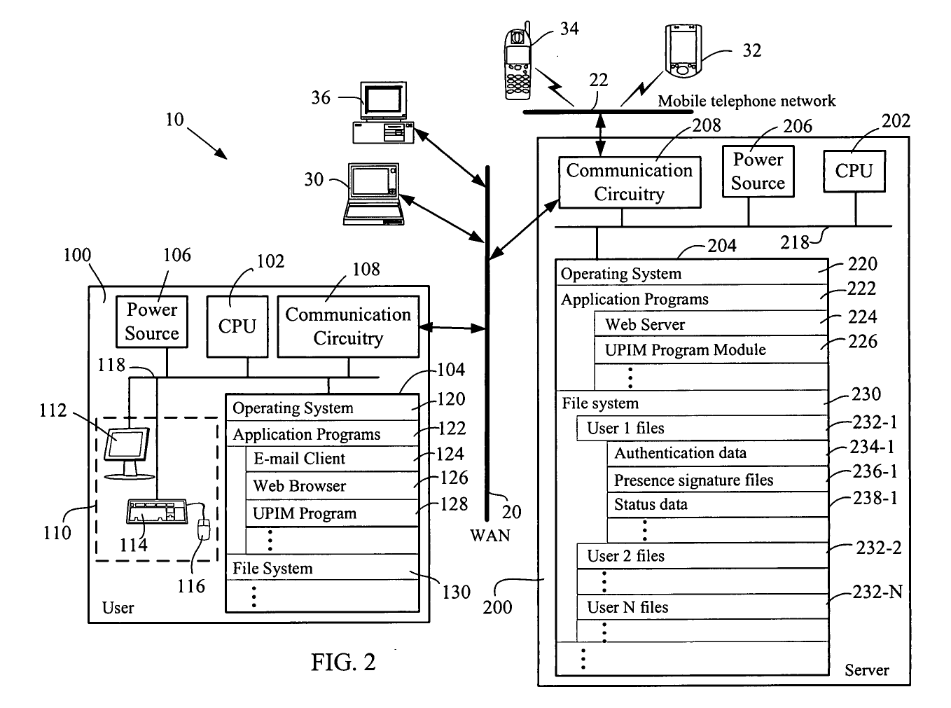

FIG. 2 provides a more detailed view of system 10, with examples of program and data modules in memory 104 and 204 of computer 100 and server 200, respectively. Memory 104 preferably includes an operating system module 120, application program module 122, and a file system module 130. Within the application programs, computer 100 includes an e-mail client for providing e-mail communication with other individuals and devices over network 20. Suitable e-mail applications include Microsoft Outlook, Lotus Notes, Eudora, and the like. Also included is a web browser module 126, such as Microsoft Internet Explorer, Netscape Navigator, etc., for sending, retrieving and displaying various types of files over network 20. A UPIIM program 128 may be used to facilitate performing universal presence indication and instant messaging communications with other individuals and devices as described herein. File system 130, may be used for managing data and program files within computer 100. Although not shown, subscriber computers or devices 30, 32, 34, 36 preferably are processor-based devices like computer 100, and include similar features such as an e-mail client, web browser, or other means for communicating and viewing and interacting with web pages or other files over a over a computer network.

Like User computer 100, server 200 preferably includes a number of program modules with memory 204. Operating system 220 provides instructions for controlling overall operation of server 200. Application program module 222 is similar to module 122, and includes application programs such as a web server 224 for managing and manipulating files and data to be used and/or viewed over network 20, and a UPIIM program module to provide instructions and data for providing overall control and implementation of the universal presence and instant messaging methods of the present invention. UPIIM program module may utilize a variety of program languages or approaches. A preferred embodiment incorporates JAVA scripting and supports handling and processing of HTML documents and complies with standard instant messaging and presence protocols, message formatting, address resolution, E-mail protocols such as SMTP, POP3, IMAP, etc., as are known in the art.

In a preferred embodiment UPIIM module 226 works in conjunction with Web module 224 to provide presence signature files, communication windows, presence status, instructions, etc. to facilitate real-time communication between User 100 and one or more Subscribers 30, 32, 34, 36 as shown and described herein. File system 230 preferably includes files 232 associated with a number of Users, such as authentication data 234-1, presence signature files 236-1, on-line status data 238-1, or files corresponding to a particular Subscriber or chat session. Files 232 may be stored in volatile or non-volatile memory, depending upon the type of information stored. Although User files 232 are shown as distinct files or modules within file system 230, one skilled in the art will appreciate that information, data, and files related to a particular User, Subscriber or chat session may be manipulated, stored, or managed in a variety of ways without departing from the scope of the present invention.

As described with respect to computer 100, server 208 also includes communications circuitry 208 for communicating with external devices, e.g. over one or more networks such as wide area network (WAN) 20 and mobile telephone network 22. Communications circuitry 108 includes a network interface card, modem, router, or other suitable device for providing a communication connection with networks 20, 22 as described above. In a preferred embodiment, network 22 is connected to or a subset of network 20. Mobile telephone network 22 allows text, voice, image and other data to be communicated between wireless devices 32, 34 and server 200 and computer 100.

### General Overview of the UPIIM System and Method

UPIIM system 10 is configured to allow a registered User 100 of the to broadcast his presence to and communicate with any number of potential Subscribers 30,32,34,36. Subscribers need not be registered Users of UPIIM 10 or any other instant messaging system. An advantage of the UPIIM system of the present invention is that it provides presence indication of a User to non-Users and enables instant communication between these parties. The UPIIM system also does not require that the User or the recipient download and install any new application to use the system.

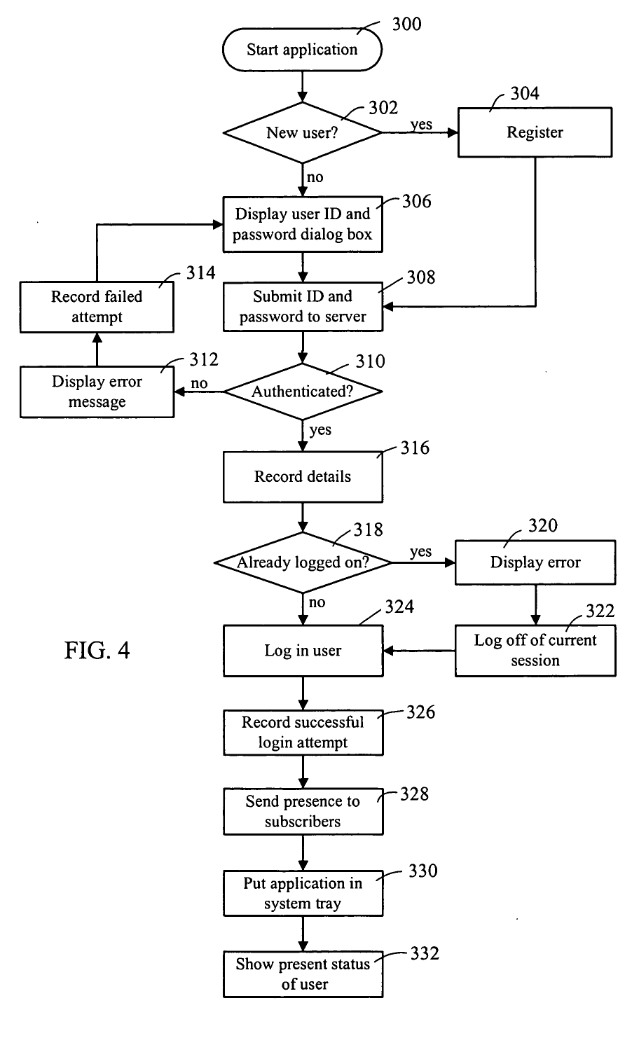

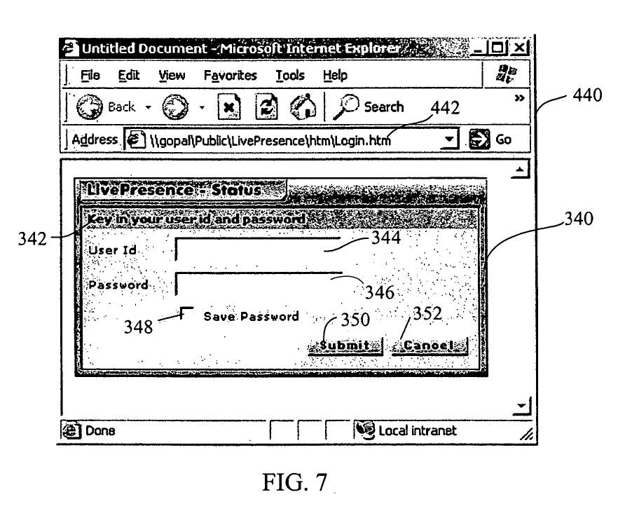

Before providing a detailed overview of the system and method, it is helpful to provide a general explanation of the characteristics of two main entities within the system: “User(s)” and “Subscriber(s)”. As will be described in more detail with respect to FIGS. 4-8, the User is the entity that logs in to the UPIIM system (e.g., in UPIIM system program module 226). The system 226 authenticates the User and registers the presence of that User within network 20. Subscribers are entities who have currently subscribed for the presence of a particular User. In other words, Subscribers are currently viewing the presence state of a particular User on the UPIIM system. Potential Subscribers are recipients of a presence signature, but who have not yet subscribed to the presence state of, or requested a chat with, a User. For convenience, unless otherwise noted, the term “Subscriber” is used herein to include both Subscribers and potential Subscribers and their computer devices. Subscribers and potential subscribers may simply also be called “recipients” of a presence signature or message from the User, or may generically be called users of a particular computer, device or of the overall system. A User and a Subscriber can each have a presence state associated with them.

Every Subscriber will have one User associated with itself. In other words, a Subscriber subscribes to the presence of exactly one User. A User on the other hand can have multiple Subscribers associated with itself. In other words, many Subscribers could be subscribed for the presence of a given User. A User can also be subscribed for the presence of one or more Subscribers. In effect, this becomes a one-to-many relationship between the Users and their associated Subscribers. One User can have many associated Subscribers but as defined one Subscriber can have only one associated User for a particular session.

It is helpful to mention that the entities mentioned above are logical and not physical. In other words, it is not necessary that a UPIIM system User be a physical human being. Also, the UPIIM system identifies Users and Subscribers and not physical humans. This also means that a physical person can be known as different Users and different Subscribers to the UPIIM system. A person “A” can be logged into UPIIM system as a User and can also be a Subscriber to another User “B” at the same time. So the entities should not be confused with physical human beings.

In one embodiment, User 10 notifies potential Subscribers of his presence on the network through an embedded “presence signature”. A presence signature 60 can be a text, graphic or other tag with updateable presence status that is embedded into an email, web page, or other file on a mobile, internet-based, wired, wireless or other networked system. User 10 can distribute the signature 60 to any user of any email, web page, mobile, internet-based, wired, wireless or other networked system, and use the presence signature to facilitate instant communication between him and any number of potential “Subscribers”, or recipients of the presence signature.

The program module, or UPIIM System Module 226 further facilitates broadcasting a user's presence in any environment that supports an HTTP call, including the aforementioned environments, with a presence indicator. The presence indicator may be an icon embedded in a conspicuous location in the environment, such as a signature file, and is viewable by any subscriber of the environment without regard to the subscriber's service provider.

### Overview of Subscribing to User

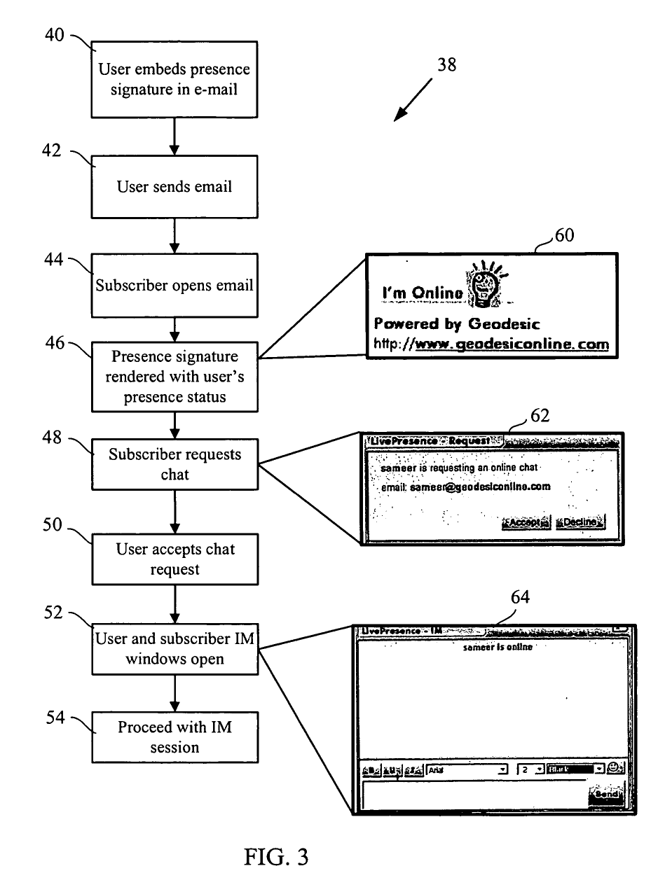

FIG. 3 provides a general overview of a process for initiating an instant message communication between a registered User 10 and an unregistered “Subscriber”, using the example of a presence signature embedded in e-mail. In step 40, a User embeds a previously-created presence signature file in the body of an e-mail message. In one embodiment, the presence signature file is a hypertext markup language (HTML) file with an address, or uniform resource locator (URL), link to one or more files on server 200. The User then sends 42 the e-mail to one or more potential Subscribers. After the potential Subscriber opens the e-mail in step 44, the presence signature file retrieves the User's presence status (e.g., “online” or “offline”) from server 200 and in step 46 renders the corresponding presence signature 60. Preferably, Subscriber's computer or device 30, 32, 34, 36 supports HTML calls such that it can automatically communicate with server 200 when the presence signature is rendered.

Subscriber can request an instant messaging (IM) chat session 48 with the User, e.g., by clicking on the “I'm Online” portion of the rendered signature 60. The signature includes an HTML link or similar coded device that communicates with program module 226 to retrieve the updated presence status of the User and to open web-based windows or pages on the Subscriber's computer that instruct the Subscriber on how to request a chat session, send a text message, or perform some other communication with the User. In a preferred embodiment, the Subscriber's computer does not require any proprietary messaging software other than a standard web browser such as Microsoft Internet Explorer or some other means of viewing web pages from server 200. Subscriber computer 30, 32, 34, 36 preferably also support JAVA scripts and the like to facilitate interaction with the presence signature.

When Subscriber requests a chat, a “Request” dialog box 62 is displayed on User's screen, and User has the option of accepting or declining the request (other options, such as ignoring or blocking a request are also possible). When the User accepts the request in step 50, IM windows 64 open for the User and Subscriber. Subscriber and User then proceed with IM session, which is generally, although not necessarily, hosted and controlled by server 200. Typically, Subscribers' IM window opens within a web browser or similar standard application on Subscribers' device, such that Subscriber does not require any particular IM client software. User's device may utilize UPIIM software, a web browser, or other software to process the chat request and perform the IM session.

### User Login

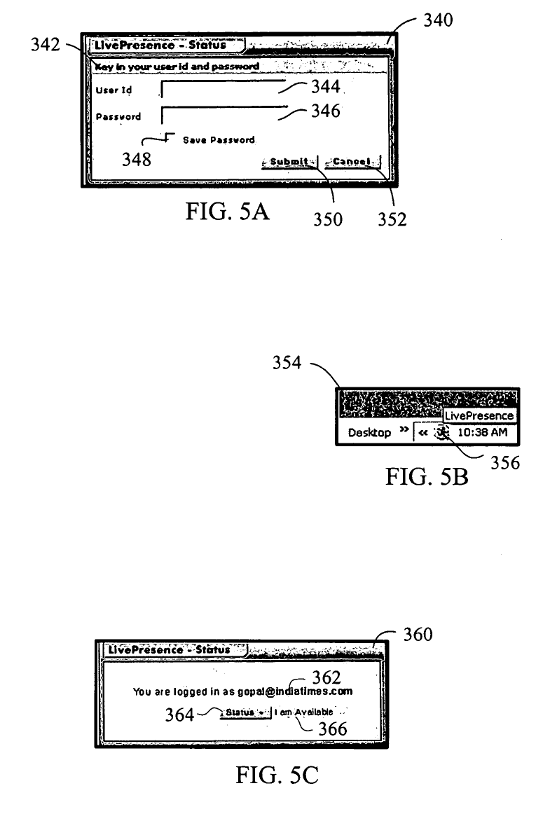

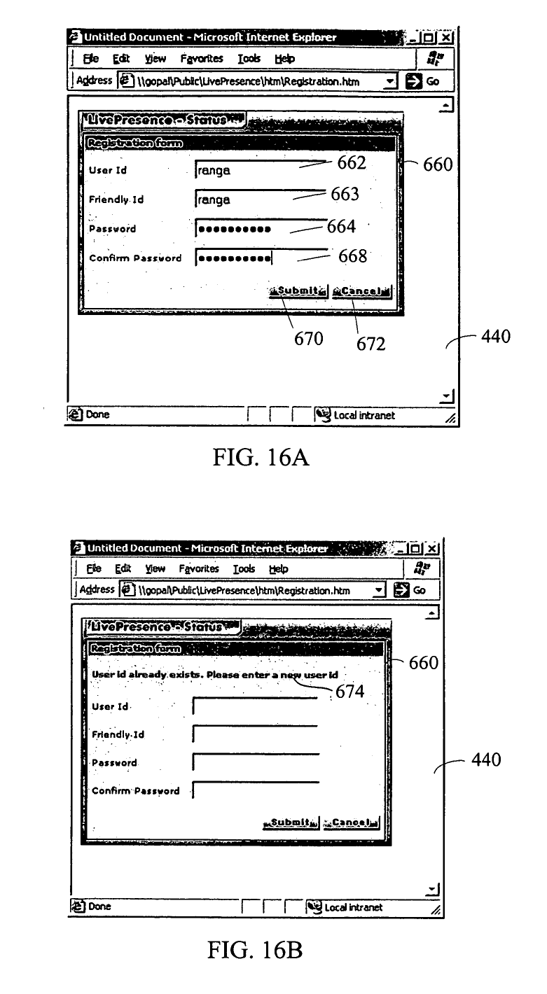

FIGS. 4 and 5 provides details regarding the process of a User logging into the UPIIM system using application software 128 on computer 100. After application is started 300, a dialog box 340 (see FIG. 5A) is displayed with fields for entering User ID 344 and Password 346. Dialog box 340 also includes an option to save password 348, as well as Submit 350 and Cancel 352 buttons. Not shown in this view of dialog box 340 is an option to register 304 if the user is new 302 (see FIG. 16A and 16B).

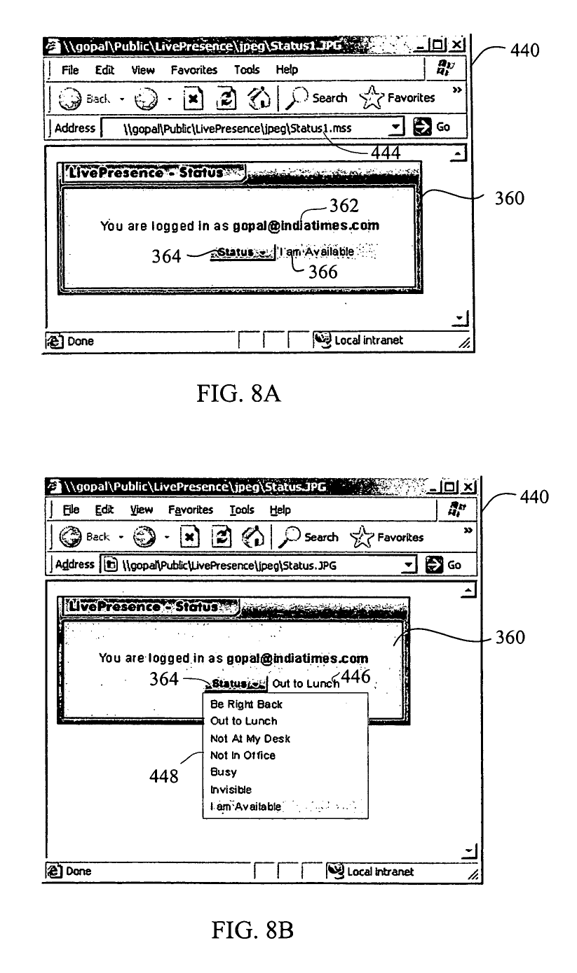

After user enters ID and password and submits the information 308, the server application authenticates 310 the user. If user is not authenticated, an error message is displayed 312 and the failed attempt is logged, or recorded 314. If the user is authenticated, the details are logged 316 and the application communicates with the server to make sure that the user is not already logged on 318 on a different device. If not, then the user is logged in 324. If the user was already logged in, an error message is displayed 320 in an application window and the user is logged off of the current session 322 before being logged in 324 for the new session. The successful login is then recorded 326. Once logged in, the server sends the User's current presence status to all subscribers 328 (or potential subscribers with open presence signatures). The application is then put in the system tray 330 as shown in FIG. 5B, as depicted by icon 356. The application then in step 332 displays a dialog box 360 showing the present status 366 of user with User ID 362. Dialog box 360 includes a status selector 364 to change status if desired (See FIG. 8B).

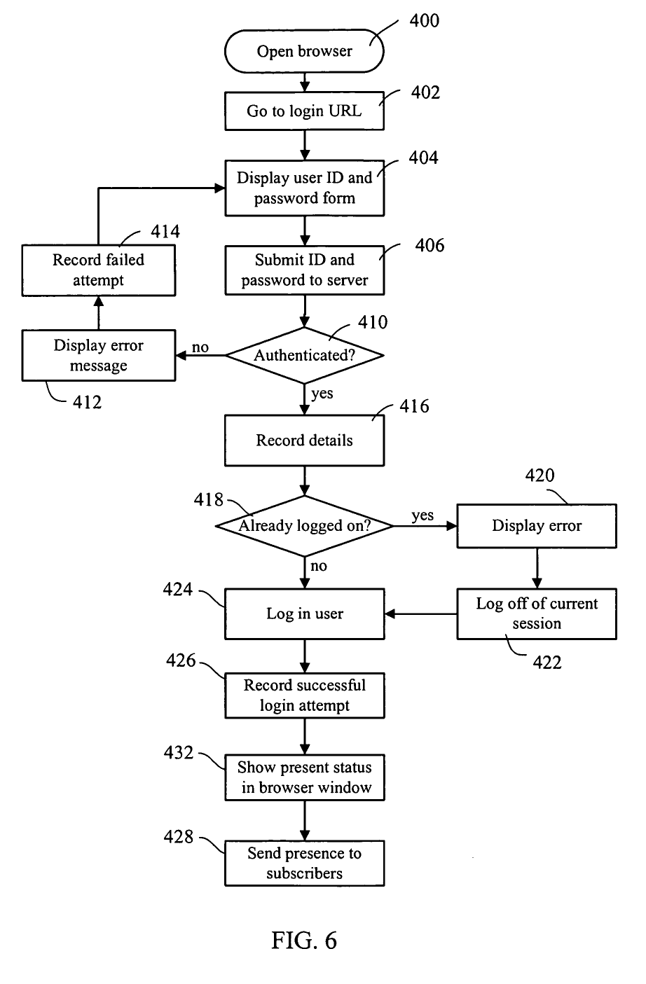

FIGS. 6-8 provides details regarding the process of a User logging into the UPIIM system using a web browser on computer 100 to communicate with server 200. User begins by opening browser 400 and entering the login address, or URL 442, on server 200. The user ID and password request form 340 is displayed 404 as described above, only this time form 340 appears within a browser window 440 (here a Microsoft Internet Explorer window). All other features of form 340 are the same as above. Steps 408-426 are also essentially the same as corresponding steps 308-326 above. One skilled in the art will appreciate that certain instructions or processes can be provided by the application program 128 of FIG. 4 or by server 200 through the web browser.

In this embodiment, although not necessarily, presence status of the user is sent 328 to subscribers after showing the present status 432 in the browser window 440 as shown in FIG. 8A. The URL 444 for the status dialog box 360 is also displayed. FIG. 8B shows the optional Status Selector 364 with a pull-down menu of selectable status indicators so that the user can change his presence status, for example, from “I am Available” 336 to “Out to Lunch” 446.

### Presence Indication and Messaging using the UPIIM System

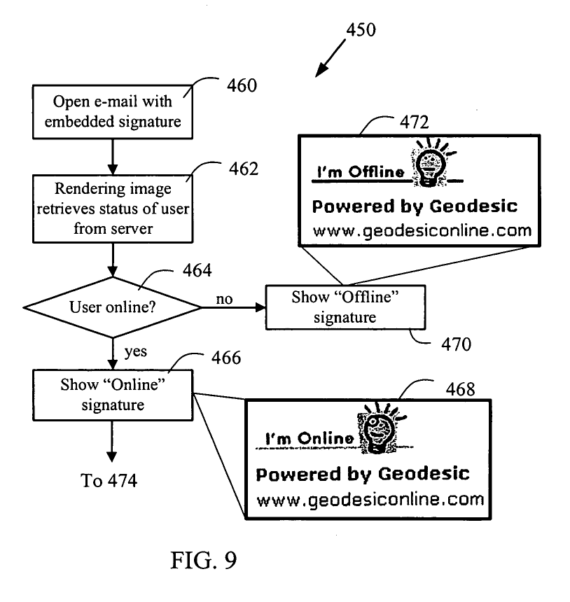

FIGS. 9-14 provide a more detailed description of a preferred method of subscribing to a User's presence signature and processing an instant messaging session. Referring to FIG. 9, the process 450 of retrieving the appropriate presence signature 468, 472 from server 200 begins when a potential subscriber opens an e-mail message with an embedded signature file 460. After the e-mail is opened 460, the signature file includes instructions (e.g., URL link) to retrieve User's current status from server 200. If use is online 464, the “Online” presence signature 468 is delivered and displayed 446 to the subscriber. If, at step 464, User is offline (or otherwise desires to appear offline, e.g., by selecting an optional “invisible” status), then the “Offline” presence signature 472 is delivered and displayed 470 to subscriber.

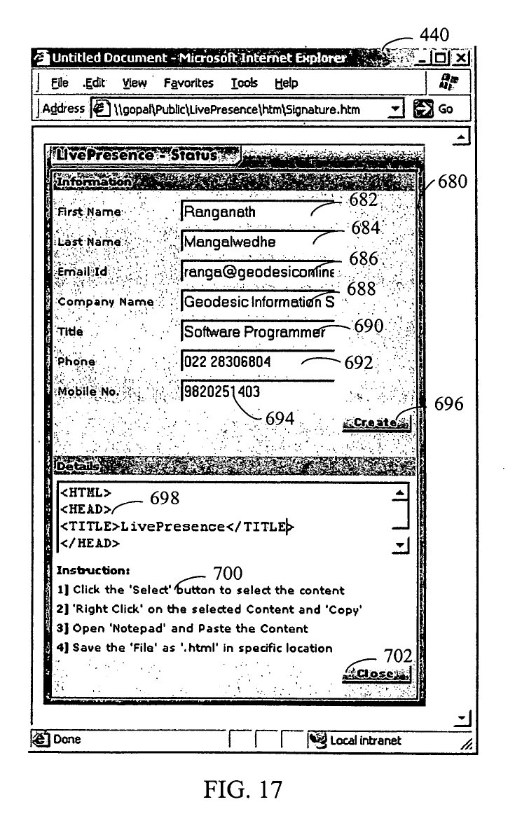

Note that the process shown in FIG. 9 begins with a presence signature file that has already been created and embedded into an e-mail, web page, or other document or file. FIG. 17 shows a web-based form used for creating an HTML presence signature file, along with instructions for saving the file so that it may be copied into, e.g., embedded, an e-mail, web page, etc. In a preferred embodiment, the User has an option of creating and/or updating such a signature file any time after registering as a User as shown in FIGS. 16A and 16B,

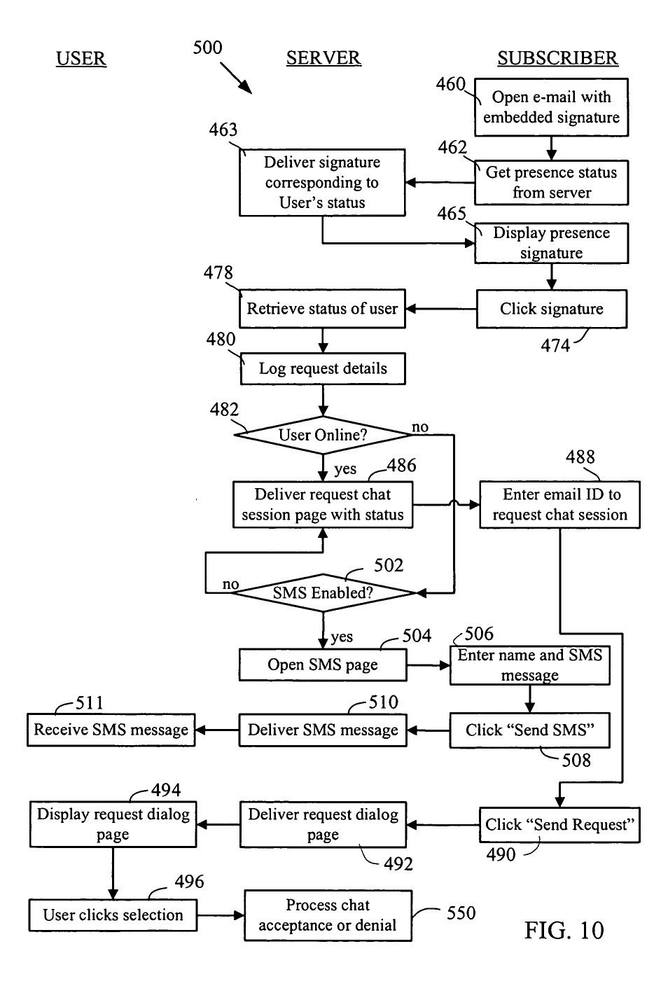

Referring now to FIG. 10, an overall method of subscribing to a User's presence signature and processing an instant messaging session is shown, including where in system 10 each step may take place (e.g., User, Server, or Subscriber devices). Note that this method is only an example; alternative methods may involve additional or different steps or arrangement of steps without departing from the scope of the invention. As described above, opening an e-mail, web page, etc. with an embedded signature 460 retrieves the user's presence 462 form server, which delivers 463 the signature file corresponding to the User's status. The presence signature is then displayed 465 for the subscriber on the display of the subscriber's computer or other device.

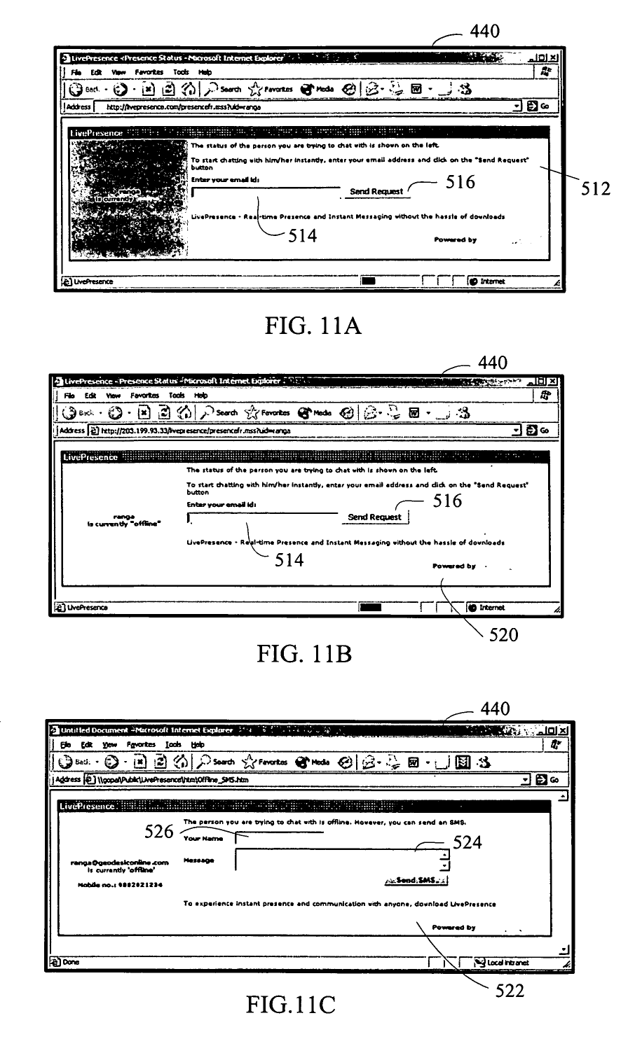

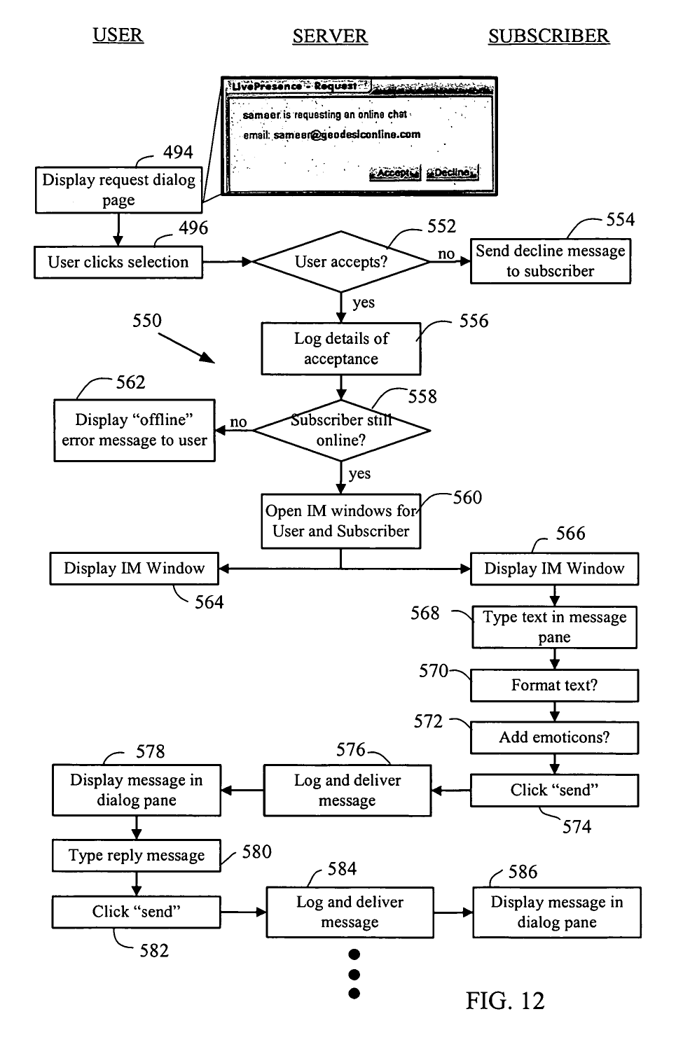

Clicking on the signature 474 (e.g., the “I'm Online” portion, or some other portion of the signature that includes a link or other call to the server) retrieves the current status of the User 478 from server 200, which then logs the request details 480 and delivers the corresponding request chat session page 512, 520 or 522 (also called Request Page 512, 520 or 522) of FIG. 11A, 11B and 11C, respectively, in subscriber's browser window 440. If user is online 482, then step 486 delivers Request Page 512 of FIG. 11A, which shows User's status as “Online”. Page 512 includes a field for entering subscriber's email ID 514 and a button to send request 516 for a chat session. If User is offline, but the SMS (e.g., text messaging) function is not enabled, then step 486 delivers Request Page 520 of FIG. 11B. By entering email ID and selecting the request chat button 516 in step 490, a Request Dialog page as shown in FIG. 12 is displayed to the User. User clicks a selection 496, and the selection is processed 550 as described with respect to FIG. 12.

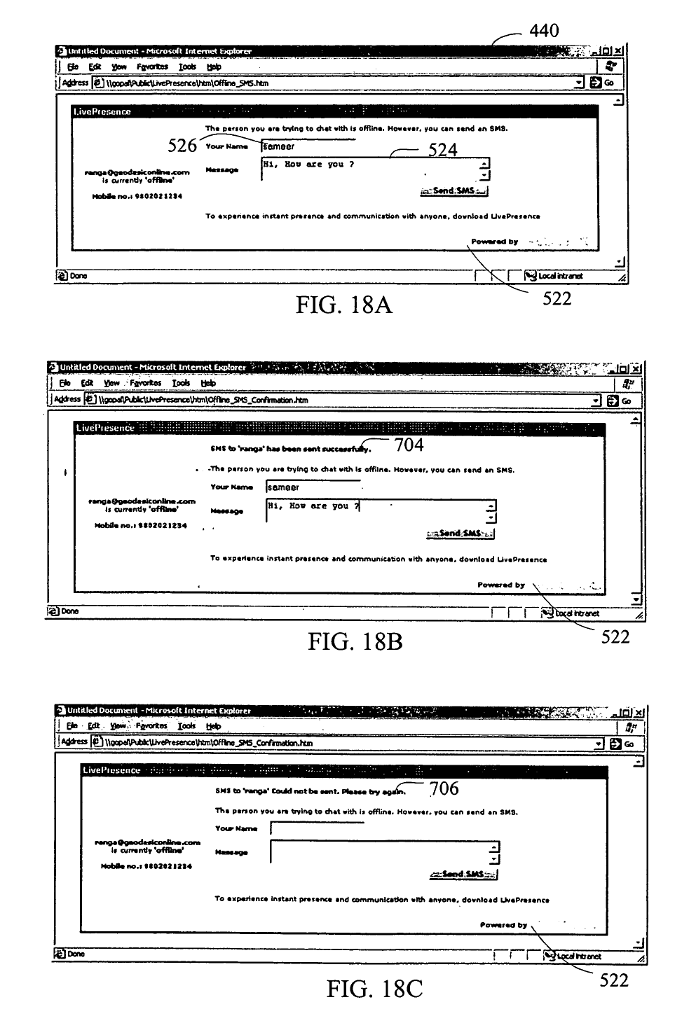

If, in step 482 User is offline and SMS is enabled 502, then server 200 opens an SMS page 522 of FIG. 11C. SMS page 522 includes fields for name 526 and message 524, along with User's mobile number. If subscriber desires, he can enter the name and message 506 (and as shown in FIG. 18A) and click send 508 to deliver the SMS message 510 so that User receives the message 511 on his device 100. FIGS. 18B and 18C depict screenshots of subscriber SMS windows 522, where FIG. 18B includes a notification that the SMS was sent successfully 704, and FIG.1 8C includes a notification that the SMS could not be sent 706.

Referring now to FIG. 12, process 500 continues at step 552 where the server 200 processes User's selection. If user does not accept 522, then a decline message is displayed to subscriber 554. FIG. 15 depicts a screenshot of a declined request dialog 654 in window 440.

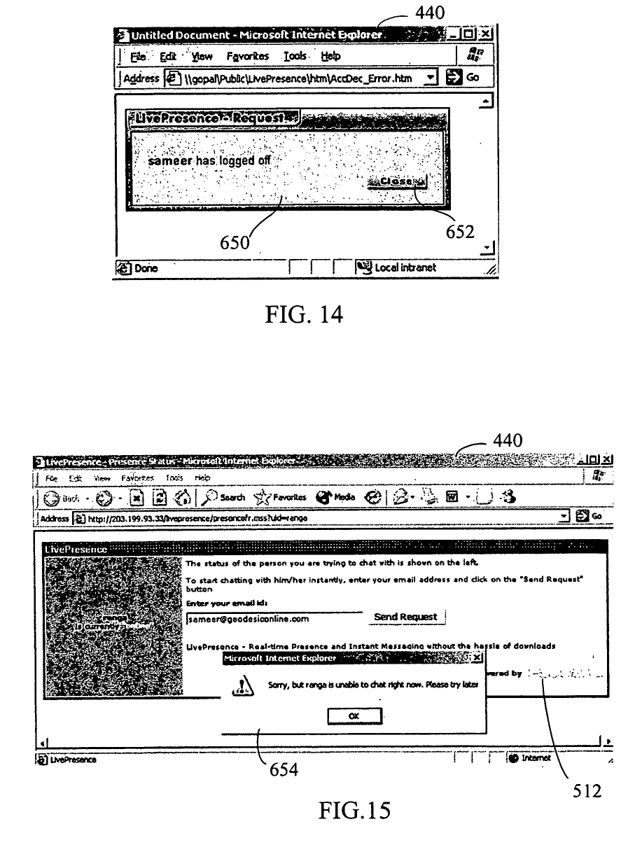

If user accepts 522 the chat request, then the server logs the details of the acceptance 556 and checks to make sure that Subscriber is still online 558. If subscriber is not still online, then in step 562 a subscriber offline dialog 650 is displayed to User (see dialog box 650 in FIG. 14). If subscriber is still online, then the server opens IM windows for both User and Subscriber in step 560 and the IM widows are displayed in 564 and 566, respectively.

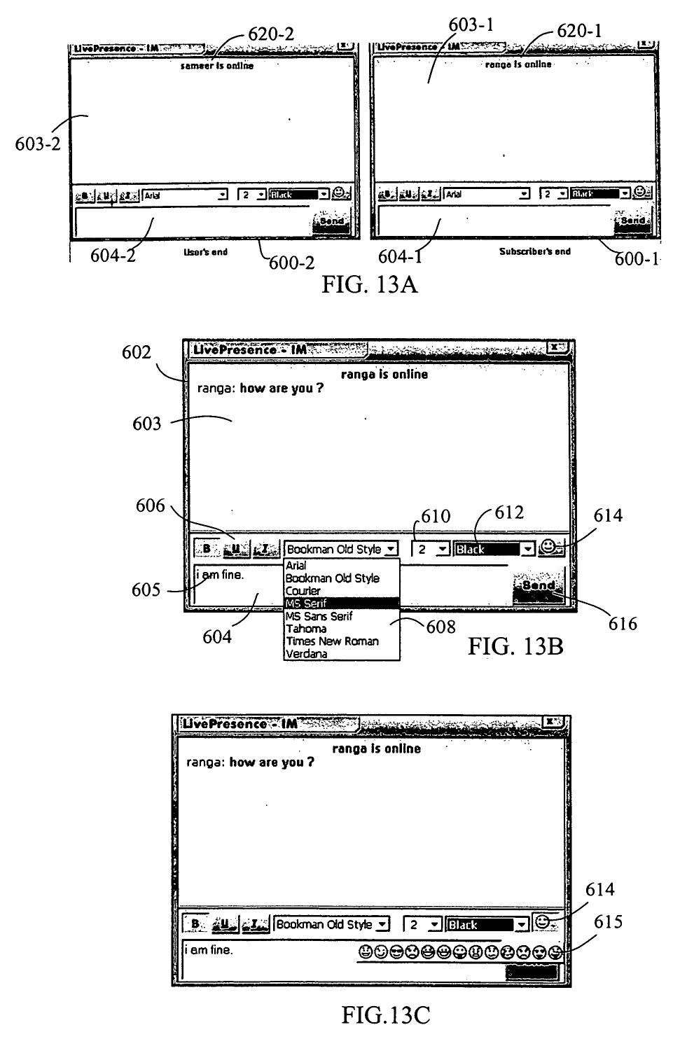

FIG. 13A shows screenshots of IM windows 600-1 and 600-2 for Subscriber and User. Each box includes a message entry pane 604 where new messages are typed, a running dialog pane 603, and a status indicator 620. Steps 568-586 of FIG. 12 and screenshot FIGS. 13B and 13C depict a method of conducting an IM session, which occurs similar to other IM applications. Briefly, one of the parties, in this case the Subscriber, types 568 text 506 into the message pane 604. As shown in FIG. 13B, IM window 600 includes the option of formatting the text (step 570) using font attribute buttons 606 for bold, underline, or italics, a font style menu 608, and a font size menu 610. FIG. 13 C also depicts a number of emoticons that may be selected and inserted into the message (step 572). Once a user finishes typing, he click 574 the send button 616 and the message is logged and delivered 576 to User, where it is displayed 578 in dialog pane 603. The User can then reply in kind, by typing 580 and sending 582, whereupon the message is logged and delivered 584 to Subscriber and displayed 586, e.g., in scrolling fashion in dialog pane 603. In alternative embodiments, User and Subscriber can also have a voice conversation or collaborate with each other using tools including but not limited to tools such as “File Transfer”, “Whiteboard” and “Application Sharing”.

Referring to FIG. 16A, an entity may register to be a User of the UPIIM System through a registration screen 660 in a browser 440. Registration information includes a unique User ID 662, a Friendly ID 663, and a Password 664, 668. Once the information is entered, the user selects the submit button 670, or optionally can cancel the registration process using button 672. If the entered User ID is not unique, the User will be asked to enter a new ID 674.

After User is registered, he can create a presence signature as described earlier. Briefly, a signature window 680 includes fields for entering parameters such as first name 682, last name 684, email ID 686, company name 688, title 690 phone 692 and mobile number 694. When the desired information entered, the User can select Create 696 to generate the HTML signature. Also shown in window 680 are details 698 of the HTML code as well as instructions 700 for downloading or saving the signature file for embedding into another file or object. In an alternative embodiment, the presence signature file is created by the UPIIM program module upon registration of the user. The user can then download the signature file and send it along with e-mails or any other document or file that supports HTML calls. When a recipient of the e-mail or other file views the message, the signature file updates the presence of the user by retrieving the presence from the server. The recipient can click on the presence image to initiate a session with the user. One skilled in the art will appreciate that while the present embodiment is described using HTML files and links for communicating over the internet or other network, other types of scripting and computer languages may be used.

The following is an example of a presence signature file that may be used according to the present invention:

<DIV align=left>
<A target=′_blank′href=′http://69.59.142.60:10005/IMaround/presencefr.mss?userid=kiran′>
<IMG alt=′My Presence′
src=′http://69.59.142.60:10005/IMaround/getpresence.mss?userid=kiran′
border=0> </A></DIV>
<DIV align=left><FONT face=′Lucida Sans Unicode′ color=#008000 size=1>
Click on the image to chat with me</FONT></DIV>
<DIV align=left><FONT size=1><FONT face=′Lucida Sans Unicode′>Powered by
<STRONG>IMaround</STRONG></FONT></FONT></DIV>
<DIV align=left><FONT face=′Lucida Sans Unicode′ size=1>
Patent pending presence and IM technology from Geodesic</FONT></DIV>
<DIV align=left><FONT face=′Lucida Sans Unicode′ size=1>
<A target=′blank′href=′http://www.geodesiconline.com′>http://www.geodesiconline.com
</A></FONT></DIV><DIV align=left><FONT face=Tahoma size=2>
</FONT>&nbsp;<DIV></BODY></HTML>

The following definitions and descriptions apply to the descriptions herein:

Instant messaging is the ability to easily see whether a chosen friend or co-worker (or ‘buddy’) is connected to the Internet and, if they are, to exchange messages with them.

An Instant Messaging system is a system that provides Instant Messaging services.

Presence state is the online state of a person, which can be set by the person and can be viewed by others who subscribe to this User's presence. This could be a variety of states such as “available”, “Busy”, “Not Available” and the like.

A User is an entity who is identifiable by the system by a unique value. Typically, a User is a registered user of the universal presence and instant messaging system . However, a User does not necessarily map to a physical person. The system would validate the User based on the credentials supplied during authentication, which would in most cases be the password. The word “user” may also be used herein as it common meaning, e.g., to identify any person using the system , a computer, or another device, including both User and Subscribers.

The IEEE is a non-profit, technical professional association of more than 380,000 individual members in 150 countries. The full name is the Institute of Electrical and Electronics Engineers, Inc., although the organization is most popularly known and referred to by the letters I-E-E-E. Through its members, the IEEE is a leading authority in technical areas ranging from computer engineering, biomedical technology and telecommunications, to electric power, aerospace and consumer electronics, among others.

The Hypertext Transfer Protocol (HTTP) is the set of rules for exchanging files (text, graphic images, sound, video, and other multimedia files) on the World Wide Web. Relative to the TCP/IP suite of protocols (which are the basis for information exchange on the Internet), HTTP is an application protocol.

A Web Browser is an application program that provides a way to look at and interact with all the information on the World Wide Web.

An emoticon is a short sequence of keyboard letters and symbols, usually emulating a facial expression, expressing a feeling that supplements the message.

File transfer is the movement of one or more files from one location to another.

A Whiteboard is a space on the display in which one or more participants write or draw, using a mouse, keyboard, or other input device.

Application sharing includes sharing of one application between two or more people.

A Bulletin Board System (BBS) is a computer or an application dedicated to the sharing or exchange of messages or other files on a network.

A Weblog is a Web site of personal or non-commercial origin that uses a dated log format that is updated on a daily or very frequent basis with new information about a particular subject or range of subjects.

A Web page is typically an HTML file that is used to display content on the World Wide Web.

While the foregoing description and drawings represent a preferred embodiment of the present invention, it will be understood that various additions, modifications and substitutions may be made therein without departing from the spirit and scope of the present invention as defined in the accompanying claims. In particular, it will be clear to those skilled in the art that the present invention may be embodied in other specific forms, structures, arrangements, proportions, and with other elements, materials, and components without departing from the spirit or essential characteristics thereof. The presently disclosed embodiments are therefore to be considered in all respects as illustrative and not restrictive, the scope of the invention being indicated by the appended claims, and not limited to the foregoing descriptions. Furthermore, it should be noted that the order in which the process is performed may vary without substantially altering the outcome of the process.

1. A method for messaging communication on a computer network, comprising:
embedding a signature file into an email message, the signature file including a presence indicator for indicating the presence of a user on a network;
sending the email message from a user using a first computer to a recipient using a second computer;
opening the email message on the second computer, said email message including the signature file and presence indicator;
communicating with a server using the signature file to retrieve the user's current presence status.;
establishing a messaging session between the user and the recipient through the server.

2. The method of claim 1, wherein the messaging session is an instant messaging session.

3. The method of claim 2, wherein establishing the instant messaging session further comprises:
requesting an instant messaging session with the user;
accepting the instant messaging session by the user; and
conducting the instant messaging session, wherein the messaging session is managed by a program module on the server.

4. The method of claim 1, wherein the signature file includes an HTML link to the sever, such that selecting the signature file activates the HTML link and initiates the instant messaging session.

5. The method of claim 1, wherein the recipient computer is any processor-based device capable of communicating over a computer network.

6. The method of claim 5, wherein the computer is any of a personal computer, a, portable computer, a hand-held computer device, a mobile telephone, or a tablet PC.

7. The method of claim 1, wherein the user and recipient conduct the instant messaging session over the network using a web browser application.

8. The method of claim 1, wherein opening the e-mail message further comprises rendering the signature file on the recipient's computer.

9. The method of claim 8, wherein rending the signature file comprises communicating with the server to retrieve the user's current presence status.

10. The method of claim 1, further comprising:
logging on to the server by the user;
updating the user's presence status in response to the login; and
notifying the recipient of the user's presence on the internet.

11. The method of claim 1, wherein establishing the messaging session includes sending a text message to the user.

12. The method of claim 11, wherein the first computer is a cellular telephone adapted to receive instant messages.
